(19) United States
(12) Patent Application Publication
(10) Pub. No.: US 2019/0379649 A1
(43) Pub. Date: Dec. 12, 2019

(54) System and Method for Mobile Platforms Wireless Communication Data Integrity and Storage for Aiding with Anomaly Investigations

(71) Applicant: KinisiBlockChain Solutions, LLC, Charles Town, WV (US)

(72) Inventors: Alden Fuchs, Leesburg, VA (US); Mike Hess, Charles Town, VA (US)

(21) Appl. No.: 16/434,745

(22) Filed: Jun. 7, 2019

Related U.S. Application Data
(60) Provisional application No. 62/682,393, filed on Jun. 8, 2018.

(51) Int. Cl. H04L 29/06; G06F 16/182; H04L 9/08

(52) U.S. Cl. CPC H04L 63/061; G06F 16/1824; H04L 2209/38; H04L 63/065; H04L 9/0819; G06F 16/1834

(57) ABSTRACT

A telemetry packet is generated using a telemetry system of each device of a group of N self-propelled mobile devices. Each device of the group encrypts its telemetry packet using its blockchain security system and transmits the encrypted telemetry packet to a next device of the group using its transceiver. The next device decrypts the received encrypted telemetry packet validates the decrypted telemetry packet as a valid blockchain packet, and stores the decrypted telemetry packet in a blockchain ledger storage of the next device using the blockchain security system. The next device transmits the received encrypted telemetry packet using a transceiver of the next device to another next self-propelled mobile device of the group, and repeats the steps of decrypting, validating, storing, and transmitting telemetry packet until each blockchain ledger storage of each of the N-1 self-propelled mobile devices of the N self-propelled mobile devices includes the telemetry packet.

### CROSS-REFERENCE TO RELATED APPLICATION

This application claims the benefit of U.S. Provisional Patent Application No. 62/682,393, filed Jun. 8, 2018, the content of which is incorporated by reference herein in its entirety.

### INTRODUCTION

The teachings herein relate to using a blockchain distributed ledger to secure telemetry data. More specifically, systems and methods are provided that secure telemetry data from a plurality of self-propelled mobile devices to a plurality of servers using a blockchain distributed ledger. The blockchain distributed ledger distributes and secures the information for real-time control, data analysis, and after an incident secured tamper-proof storage.

The systems and methods disclosed herein can be performed in conjunction with a processor, controller, microcontroller, or computer system, such as the computer system of FIG. 1.

### Telemetry Background

An ever-increasing number of self-propelled mobile devices that fly, drive on land, or navigate above or under the sea, either autonomously or semi-automatically, are producing an ever-increasing amount of data about their movements. Conventionally, self-propelled objects in motion, like commercial airplanes, have included indestructible event recorders (e.g., black boxes) that store all the measurements they make for a period of time. Unfortunately, this system of having indestructible event recorders attached to each mobile object does not scale with the number of self-propelled mobile devices currently in use and anticipated to be in use in the future.

Telemetry is the science of measuring a quantity (e.g., speed, direction, pressure, etc.) of an object remotely or from the perspective from an observer device. Telemetry has long been used to monitor the movement and performance of rockets and spacecraft.

As a result, telemetry is an ideal tool for monitoring the data produced by self-propelled objects in motion. However, one drawback of telemetry is that the data is susceptible to interception between the transmitting self-propelled mobile device and the receiving observer device.

Consequently, additional systems and methods are needed to secure telemetry data that is shared between a transmitting self-propelled mobile device and the receiving observer device.

### SUMMARY

A system, method, and computer program product are disclosed for securely transmitting and distributing telemetry data among self-propelled mobile devices. The system includes a group of N self-propelled mobile devices. Each self-propelled mobile device of the group includes a telemetry system, a blockchain security system that includes blockchain encryption key storage and blockchain ledger storage, and a wireless transceiver.

Each self-propelled mobile device of the group performs a number of steps. Each device generates a telemetry packet using its telemetry system. Each device encrypts the telemetry packet with a blockchain encryption key from a blockchain encryption key storage using its blockchain security system. Each device transmits the encrypted telemetry packet to a next self-propelled mobile device of the group using its transceiver.

The next self-propelled mobile device of the group also performs a number of steps. In step (a), the next device decrypts the received encrypted telemetry packet with a blockchain encryption key from a blockchain encryption key storage using its blockchain security system. In step (b), the next device validates the decrypted telemetry packet as a valid blockchain packet using its blockchain security system. In step (c), the next device stores the decrypted telemetry packet in a blockchain ledger storage using its blockchain security system. In step (d), the next device transmits the received encrypted telemetry packet using its transceiver to a next self-propelled mobile device of the group, and repeats steps (a)-(d) until each blockchain ledger storage of each of the N-1 self-propelled mobile devices of the N self-propelled mobile devices includes the telemetry packet.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary diagram of a system for securely monitoring the telemetry packets of self-propelled mobile devices using a blockchain ledger, in accordance with various embodiments.

FIG. 3 is an exemplary flowchart that shows a method for securely monitoring the telemetry packets of self-propelled mobile devices using a blockchain ledger, in accordance with various embodiments.

FIG. 4 is a schematic diagram of an exemplary system for securely transmitting and distributing telemetry data among self-propelled mobile devices, in accordance with various embodiments.

FIG. 5 is a flowchart showing a method for securely transmitting and distributing telemetry data among self-propelled mobile devices, in accordance with various embodiments.

FIG. 6 is a schematic diagram of a system that includes one or more distinct software modules that perform a method for securely transmitting and distributing telemetry data among self-propelled mobile devices, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

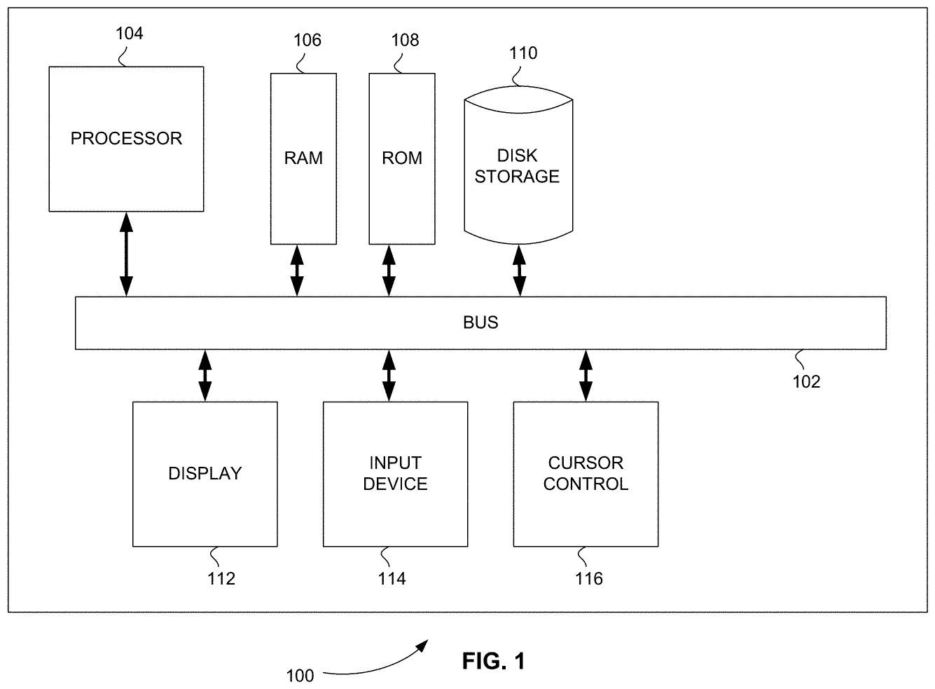

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus, implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Secure Transmission and Distribution of Telemetry Data

As described above, an ever-increasing number of self-propelled mobile devices are producing an ever-increasing amount of data about their movements. The use of indestructible event recorders attached to each mobile vehicles or device does not scale with the number of self-propelled mobile devices currently in use and anticipated to be in use in the future.

Telemetry has long been used to monitor the movement and performance of rockets and spacecraft. As a result, telemetry is an ideal tool for monitoring the data produced by objects in motion. However, one drawback of telemetry is that the data is susceptible to interception between the transmitting self-propelled mobile device and the receiving observer device.

Consequently, additional systems and methods are needed to secure telemetry data that is shared between a transmitting self-propelled mobile device and the receiving observer device.

In various embodiments, systems and methods are provided that ensure that the telemetry data of autonomous and semi-automatic remote self-propelled mobile devices that travel in space, in the air, over the ground, on the sea, or under the sea can be easily stored in a distributed tamper-proof manner. This makes compliance to regulations and incident investigations simpler as the recovery of a physical device is not required.

Peer remote self-propelled mobile devices wirelessly communicate with each other authenticating the telemetry data. In addition, these peer self-propelled mobile devices include local blockchain storage of their packets and neighboring telemetry packets. Peer remote self-propelled mobile devices can verify their actions and the actions of the originator without causing harm to any remote self-propelled mobile devices.

Observer server computers on the ground (e.g., in the cloud, etc.) can both real-time monitor the remote self-propelled mobile devices and have a tamperproof distributed blockchain ledger of the telemetry packets of all the peer devices. Unlike the conventional systems, there is no need for an indestructible on-board recording device. Also, unlike the conventional systems, there is no need for an additional collision warning system as the telemetry from all nearby peers can be analyzed.

U.S. patent application Ser. No. 15/236,695 (hereinafter the “'695 Application”), for example, is directed to managing a blockchain ledger in a telecommunications network. The '695 Application describes that a blockchain ledger is a database that is distributed among multiple computing devices. A blockchain is formed from blocks, with each block having information related to a transaction and linking the block to a prior block in the chain. The computing devices can each have respective copies of the blockchain so that no centralized or official copy of the blockchain exists and no computing device is trusted more than any other computing device. When a user initiates a transaction, some or all of the computing devices can verify the transaction. After verifying the transaction, the computing devices can include information related to the transaction into the respective copies of the blockchain. This can be more robust and secure than many other approaches.

In the '695 Application, a blockchain ledger is maintained by a plurality of telecommunications base transceiver stations. These base stations receive wireless communications from mobile devices (e.g., smartphones) that include information associated with a transaction to be included in the blockchain ledger. The base stations convert the received information into an Internet protocol (IP)-based format and update the blockchain ledger. The blockchain ledger is updated by propagating IP-based formatted information to at least another base transceiver station. In other words, in the '695 Application smartphone transactional information is stored in the blockchain ledger shared by a plurality of telecommunications base transceiver stations.

In contrast, in various embodiments of the present invention, telemetry data produced by a self-propelled mobile device (e.g., a vehicle) is stored in the blockchain ledger of other self-propelled mobile devices rather than base stations. As a result, each self-propelled mobile device is aware of the telemetry data of the other self-propelled mobile devices. As described above, for example, this means that there is no need for an additional collision warning system as the telemetry from all nearby peers can be analyzed.

In addition, in the '695 Application, blockchain information is transmitted within a conventional telecommunications network. In various embodiments of the present invention, telemetry data is shared among self-propelled mobile devices using a peer-to-peer network.

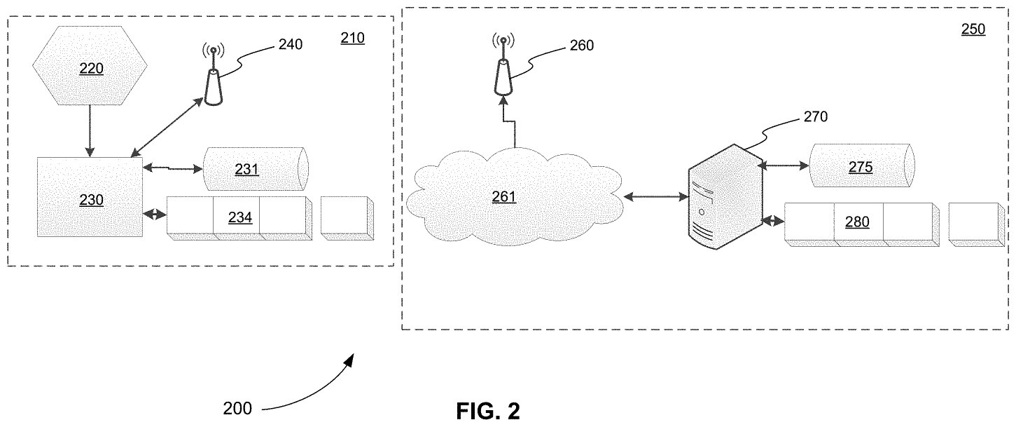

FIG. 2 is an exemplary diagram 200 of a system for securely monitoring the telemetry packets of self-propelled mobile devices using a blockchain ledger, in accordance with various embodiments. The system of FIG. 2 includes one or more self-propelled mobile devices 210 and one or more stationary observer devices 250.

One or more self-propelled mobile devices 210 and one or more stationary observer devices 250 are connected wirelessly.

One or more self-propelled mobile devices 210 include, but are not limited to, mobile vehicles such as drones, aircraft, spacecraft, ground vehicles, seagoing vehicles, and undersea vehicles. One or more self-propelled mobile devices 210 can be fully autonomous, semi-autonomous, or controlled by humans. Each of one or more self-propelled mobile devices 210 includes a number of subcomponents. These subcomponents include, but are not limited to, a telemetry system 220, a blockchain security system 230, and wireless transceiver 240.

Telemetry system 220 is the system that creates the telemetry packet and is specific to the type of remote self-propelled mobile device. The telemetry packet includes data that is common to most self-propelled mobile devices (e.g., altitude, heading, speed, global positioning satellite (GPS) coordinates, etc.). The telemetry packet also can include data that is specific to a certain type of self-propelled mobile device. For example, specific data for an aircraft can include, but is not limited to, alarms and unusual cockpit sounds.

Blockchain security system 230 is the system that provides security for the telemetry packet. It is architected to be trusted by the peer network. It applies the security method of choice by the peer network (e.g., private/public key encryption). Storage 231 is, for example, a memory used to store the keys of the security method of choice by the peer network (e.g., private/public key encryption keys). In various embodiments, storage 231 is a physical anchor to a physical self-propelled mobile device, such as, but not limited to, a subscriber identification module (SIM). In various embodiments, storage 234 is the optional local blockchain distributed ledger storage. This storage 234 can store the blocks created by this self-propelled mobile device 210 and validated by the peer network, or this storage 234 can store the entire ledger. In various embodiments, the blocks of data of storage 234 can include a DAG “Directed Acyclic Graph,” or another form of a secure message record. The form of the blocks of data of storage 234 is determined by the designer of the specific remote self-propelled mobile device.

Wireless transceiver 240 is used to transmit the secured telemetry packets to the peer-to-peer network for validation. Many different communication methods or protocols can be used to transmit the secured telemetry packets and all peers do not need to use the same method or protocol. In various embodiments, one or more stationary observer devices 250 can see all the different wireless methods or protocols by the peer network and they make sure the validated packets are sent by different methods or protocols to the other peers.

One or more stationary observer devices 250 include, but are not limited to, networked computer servers. Each of one or more stationary observer devices 250 also includes a number of subcomponents. These subcomponents include, but are not limited to, wireless transceiver 260, network 261, and computer server 270.

Wireless transceiver 260 is the wireless transceiver that connects one or more stationary observer devices 250 to one or more self-propelled mobile devices 210. There can be different transceivers 250 for a multitude of different wireless methods or protocols used by the peer network. These methods or protocols include, but are not limited to, satellite, line of sight radios like microwave, UHF, VHF, Wi-Fi, mesh networks, etc.).

Network 261 is an interne cloud or other interconnect like a private network, for example. Network 261 allows the encrypted and validated packets to make their way to and from computer server 270.

In various embodiments, there is at least one computer server 270. However, in some systems, there are a multitude of cloud servers 270. Computer server 270 is required to validate all peer telemetry packets that reach it. Computer server 270 is required to update the local blockchain ledger with all the validated packets it receives. Storage 275 is the local secure memory for storing the encryption method used by the peer network. The private/public keys for all the remote self-propelled mobile device that are part of the peer network. In various embodiments, computer server 270 may only validate a subset of the self-propelled mobile device peers but it can still store the total blockchain. Storage 280 is the local blockchain distributed ledger storage that contains all the validated telemetry packets that make their way to computer server 270.

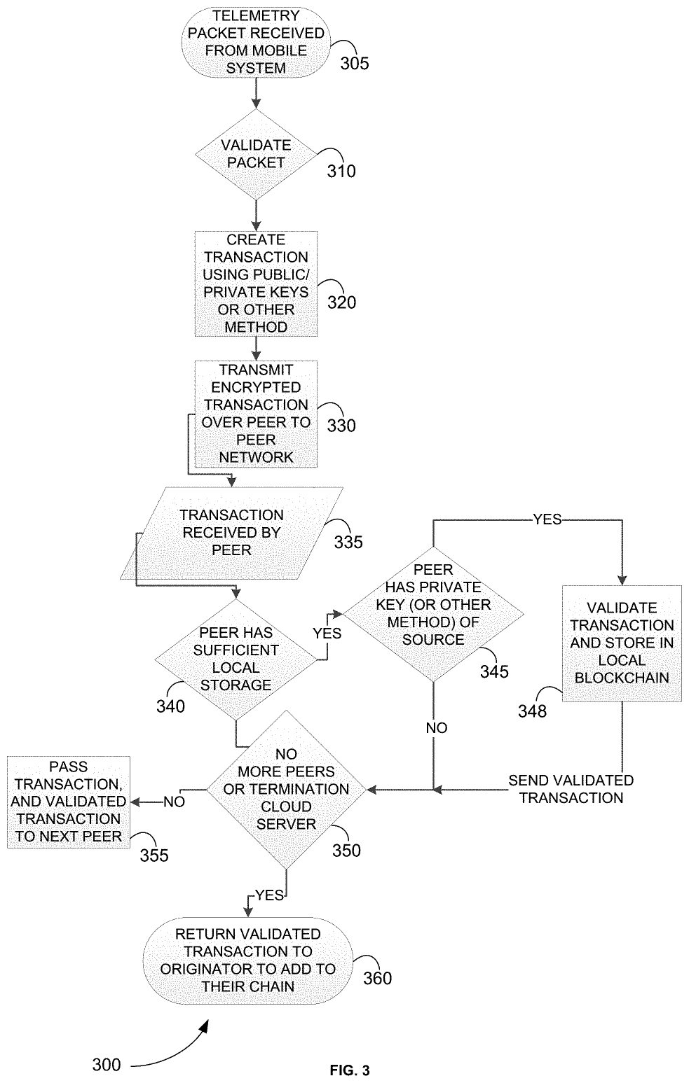

FIG. 3 is an exemplary flowchart that shows a method 300 for securely monitoring the telemetry packets of self-propelled mobile devices using a blockchain ledger, in accordance with various embodiments.

In step 305 of method 300, a telemetry packet is received from the remote terminal sub-system of a self-propelled mobile device responsible for the generation of the telemetry. This sub-system varies with the sophistication of the remote self-propelled mobile device, and its purpose (e.g., air vs ground).

In step 310, the telemetry packet's contents are verified for conformance to the peer network requirements.

In step 320, the telemetry packet is encrypted using the peer network method (e.g., private/public key encryption).

In step 330, the encrypted packet is transmitted using the transceiver on the remote self-propelled mobile device.

In step 335, the encrypted packet is received by a peer device.

In step 340, it is determined if the peer device has sufficient local storage.

In step 345, if the peer device has sufficient local storage, it is determined if the peer device has the method to decrypt the message or the tools to validate the telemetry packet.

In step 348, the telemetry packet is validated and stored into a local blockchain ledger.

In step 350, it is decided what to do with a validated packet and an encrypted packet.

In step 355, if there is a peer, the telemetry packet is passed on to the next known peer, and the validated packet is passed on to the originator.

In step 360, if this is a server computer, the validated packet is returned to the originator to add to its blockchain.

System for securely transmitting and distributing telemetry data

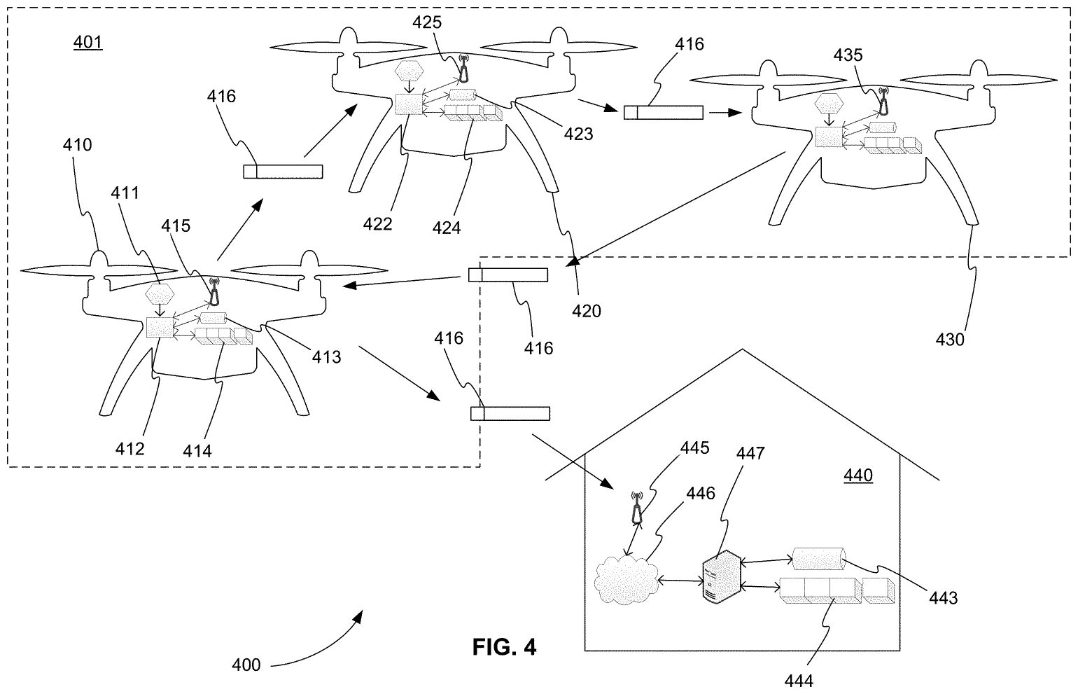

FIG. 4 is a schematic diagram 400 of an exemplary system for securely transmitting and distributing telemetry data among self-propelled mobile devices, in accordance with various embodiments. The system includes a group 401 of N self-propelled mobile devices. In FIG. 4, N=3 and the self-propelled mobile devices are depicted as drones.

Each self-propelled mobile device of the group includes a telemetry system, a blockchain security system that includes blockchain encryption key storage and blockchain ledger storage, and a wireless transceiver. For example, device 410 includes telemetry system 411, blockchain security system 412 that includes blockchain encryption key storage 413 and blockchain ledger storage 414, and wireless transceiver 415.

Each self-propelled mobile device of the group performs a number of steps.

Each device generates a telemetry packet using its telemetry system. For example, device 410 generates a telemetry packet using telemetry system 411. In various embodiments, a telemetry system includes one or more sensors and a processor.

Each device encrypts the telemetry packet with a blockchain encryption key from a blockchain encryption key storage using its blockchain security system. For example, device 410 encrypts the telemetry packet with a blockchain encryption key from blockchain encryption key storage 413 using blockchain security system 412. In various embodiments, and as described above, blockchain encryption key storage 413 is a physical anchor to 410, such as, but not limited to, a subscriber identification module (SIM). In various embodiments, a blockchain security system includes a processor.

The processor of the telemetry system and the processor of the blockchain security system can be different processors or the same processor. The term processor as used herein can include, but is not limited to, an application specific integrated circuit (ASIC), a field programmable gate array (FPGA), a controller, a microcontroller, or computer system, such as the computer system of FIG. 1.

Each device transmits the encrypted telemetry packet to a next self-propelled mobile device of the group using its transceiver. For example, device 410 transmits encrypted telemetry packet 416 to next self-propelled mobile device 420 of group 401 using transceiver 415.

The next self-propelled mobile device of the group also performs a number of steps. In step (a), the next device decrypts the received encrypted telemetry packet with a blockchain encryption key from a blockchain encryption key storage using its blockchain security system. For example, next device 420 decrypts received encrypted telemetry packet 416 with a blockchain encryption key from blockchain encryption key storage 423 using blockchain security system 422.

In step (b), the next device validates the decrypted telemetry packet as a valid blockchain packet using its blockchain security system. For example, next device 420 validates the decrypted telemetry packet as a valid blockchain packet using blockchain security system 422.

In step (c), the next device stores the decrypted telemetry packet in a blockchain ledger storage using its blockchain security system. For example, next device 420 stores the decrypted telemetry packet in blockchain ledger storage 424 using blockchain security system 422.

In step (d), the next device transmits the received encrypted telemetry packet using its transceiver to a next self-propelled mobile device of the group, and repeats steps (a)-(d) until each blockchain ledger storage of each of the N-1 self-propelled mobile devices of the N self-propelled mobile devices includes the telemetry packet. For example, next device 420 transmits received encrypted telemetry packet 416 using transceiver 425 to next self-propelled mobile device 430 of the group, and repeats steps (a)-(d) until each blockchain ledger storage of each of the N-1 self-propelled mobile devices of the N self-propelled mobile devices includes the telemetry packet. In other words, next device 430 repeats the steps of next device 420 for the same encrypted telemetry packet 416.

In various embodiments, each self-propelled mobile device of the group N self-propelled mobile devices transmits the encrypted telemetry packet to a next self-propelled mobile device of the group using a transceiver over a peer-to-peer network. For example, device 410 transmits encrypted telemetry packet 416 to device 420 over a peer-to-peer network (not shown), and device 420 transmits encrypted telemetry packet 416 to device 430 over a peer-to-peer network (not shown). Transmitting over a peer-to-peer network means using a peer-to-peer network protocol, for example.

In various embodiments, each self-propelled mobile device of the group N self-propelled mobile devices verifies that the telemetry packet conforms to requirements of the peer-to-peer network using its blockchain security system before encrypting and transmitting the telemetry packet. For example, device 410 verifies that the telemetry packet conforms to requirements of the peer-to-peer network using blockchain security system 412 before encrypting and transmitting the telemetry packet.

In various embodiments, each self-propelled mobile device of the group N self-propelled mobile devices further transmits the encrypted telemetry packet to a stationary observer device. The stationary observer device includes a wireless transceiver, a network, and a computer system that includes blockchain encryption key storage and blockchain ledger storage. For example, device 420 further transmits encrypted telemetry packet 416 to stationary observer device 440. Stationary observer device 440 includes wireless transceiver 445, network 446, and computer system 447 that includes blockchain encryption key storage 443 and blockchain ledger storage 444.

In various embodiments, the stationary observer device performs a number of steps. The stationary observer device receives the encrypted telemetry packet using its transceiver. For example, stationary observer device 440 receives encrypted telemetry packet 416 using transceiver 445.

The stationary observer device transmits the received encrypted telemetry packet to the computer system using the network. For example, stationary observer device 440 transmits received encrypted telemetry packet 416 to the computer system 447 using network 446.

The stationary observer device decrypts the received encrypted telemetry packet with a blockchain encryption key from the blockchain encryption key storage using the computer system. For example, stationary observer device 440 decrypts received encrypted telemetry packet 416 with a blockchain encryption key from blockchain encryption key storage 443 using computer system 447.

The stationary observer device validates the decrypted telemetry packet as a valid blockchain packet using the computer system. For example, stationary observer device 440 validates the decrypted telemetry packet as a valid blockchain packet using computer system 447.

The stationary observer device stores the decrypted telemetry packet in the blockchain ledger storage using the computer system. For example, stationary observer device 440 stores the decrypted telemetry packet in blockchain ledger storage 444 using computer system 447.

In various embodiments, stationary observer device 440 performs real-time traffic monitoring of group 401 using information stored in blockchain ledger storage 444.

In various embodiments, stationary observer device 440 performs incident analysis for at one of at least one self-propelled mobile device of group 401 using information stored in blockchain ledger storage 444.

In various embodiments, at least one self-propelled mobile device of group 401 is an autonomous self-propelled mobile device.

In various embodiments, at least one self-propelled mobile device of group 401 is a semi-autonomous self-propelled mobile device.

In various embodiments, at least one self-propelled mobile device of group 401 is remotely controlled by an operator.

In various embodiments, the telemetry packet generated by each self-propelled mobile device of the group N self-propelled mobile devices includes position and heading information about each device. Further, each self-propelled mobile device of the group N self-propelled mobile devices performs one or more collision avoidance, formation maneuvering, or traffic avoidance by comparing position and heading information of the device with position and heading information of each of the N-1 self-propelled mobile devices obtained from the telemetry packets stored in a blockchain ledger storage of the device.

In various embodiments, in step (c), the next self-propelled mobile device stores the decrypted telemetry packet in a directed acyclic graph (DAG) in a blockchain ledger storage of the next device.

In various embodiments, in step (d), if each blockchain ledger storage of each of the N-1 self-propelled mobile devices of the N self-propelled mobile devices includes the telemetry packet of the device, the next device transmits the encrypted telemetry packet back to the device using a transceiver the next device. For example, if device 420 and device 430 of group 401 include the telemetry packet of device 410, device 430 transmits encrypted telemetry packet 416 back to device 410 using transceiver 435 of device 430.

In various embodiments, device 410 performs a number of steps upon receiving encrypted telemetry packet 416. Device 410 decrypts received encrypted telemetry packet 416 with a blockchain encryption key from blockchain encryption key storage 413 using blockchain security system 412. Device 410 validates the decrypted telemetry packet as a valid blockchain packet using blockchain security system 412. Device 410 stores the decrypted telemetry packet in blockchain ledger storage 414 using blockchain security system 412.

Method For Securely transmitting and Distributing Telemetry Data

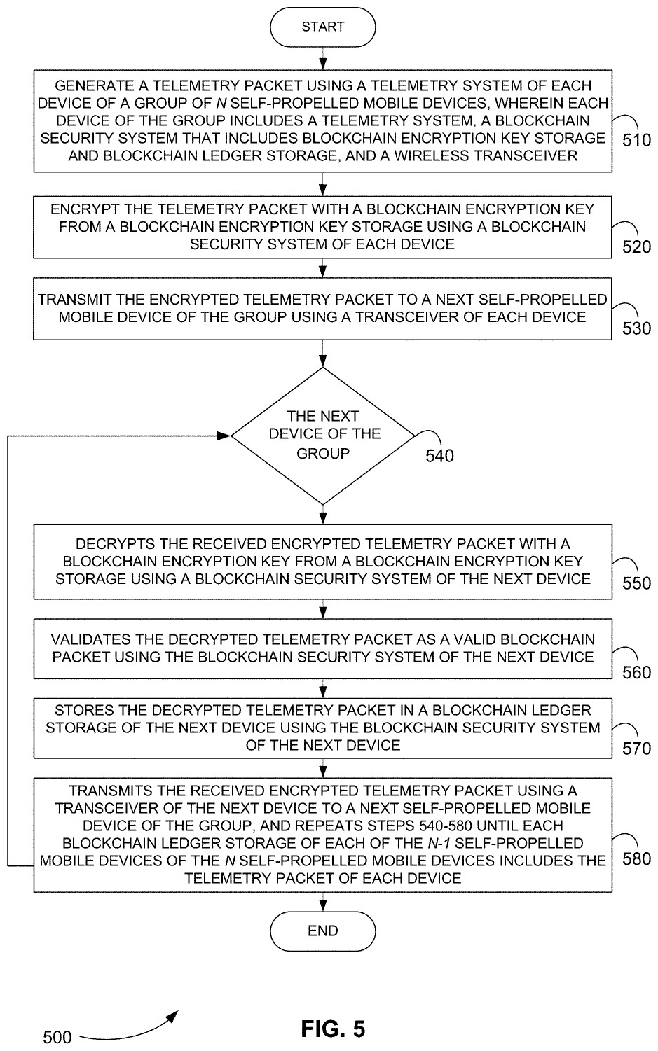

FIG. 5 is a flowchart showing a method 500 for securely transmitting and distributing telemetry data among self-propelled mobile devices, in accordance with various embodiments.

In step 510 of method 500, a telemetry packet is generated using a telemetry system of each device of a group of N self-propelled mobile devices. Each device of the group includes a telemetry system, a blockchain security system that includes blockchain encryption key storage and blockchain ledger storage, and a wireless transceiver.

In step 520, the telemetry packet is encrypted with a blockchain encryption key from a blockchain encryption key storage using a blockchain security system of each device.

In step 530, the encrypted telemetry packet is transmitted to a next self-propelled mobile device of the group using a transceiver of each device.

In step 540, for each next self-propelled mobile device of the group, a number of steps are performed.

In step 550, the next device decrypts the received encrypted telemetry packet with a blockchain encryption key from a blockchain encryption key storage using a blockchain security system of the next device.

In step 560, the next device validates the decrypted telemetry packet as a valid blockchain packet using the blockchain security system of the next device.

In step 570, the next device stores the decrypted telemetry packet in a blockchain ledger storage of the next device using the blockchain security system of the next device.

In step 580, the next device transmits the received encrypted telemetry packet using a transceiver of the next device to a next self-propelled mobile device of the group, and repeats steps 540-580 until each blockchain ledger storage of each of the N-1 self-propelled mobile devices of the N self-propelled mobile devices includes the telemetry packet of each device

Computer Program Product For Securely Transmitting and Distributing Telemetry Data

In various embodiments, computer program products include a tangible computer-readable storage medium whose contents include a program with instructions being executed on a processor so as to perform a method for securely transmitting and distributing telemetry data among self-propelled mobile devices. This method is performed by a system that includes one or more distinct software modules.

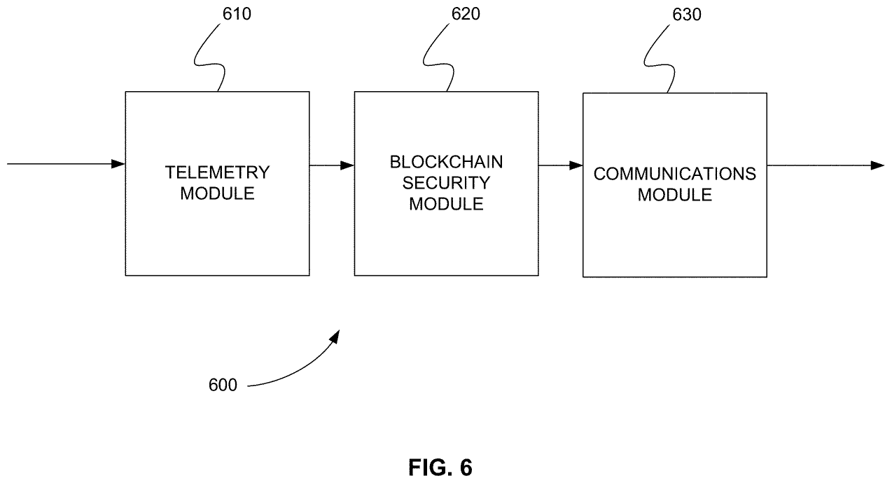

FIG. 6 is a schematic diagram of a system 600 that includes one or more distinct software modules that perform a method for securely transmitting and distributing telemetry data among self-propelled mobile devices, in accordance with various embodiments. System 600 is provided for each device of a group of N self-propelled mobile devices and includes a telemetry module 610, a blockchain security module 620, and a communications module 630.

Telemetry module 610 of each device of the group generates a telemetry packet. Blockchain security module 620 of each device of the group encrypts the telemetry packet with a blockchain encryption key from a blockchain encryption key storage. Communications module 630 of each device of the group transmits the encrypted telemetry packet to a next self-propelled mobile device of the group.

In step (a), blockchain security module 620 of the next device decrypts the received encrypted telemetry packet with a blockchain encryption key from a blockchain encryption key storage.

In step (b), blockchain security module 620 of the next device validates the decrypted telemetry packet as a valid blockchain packet.

In step (c), blockchain security module 620 of the next device stores the decrypted telemetry packet in a blockchain ledger storage.

In step (d), communications module 630 transmits the received encrypted telemetry packet using a communications module of the next device to a next self-propelled mobile device of the group, and steps (a)-(d) are repeated until each blockchain ledger storage of each of the N-1 self-propelled mobile devices of the N self-propelled mobile devices includes the telemetry packet.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for securely transmitting and distributing telemetry data among self-propelled mobile devices, comprising:
a group of N self-propelled mobile devices, wherein each device of the group includes a telemetry system, a blockchain security system that includes blockchain encryption key storage and blockchain ledger storage, and a wireless transceiver and wherein each device of the group
generates a telemetry packet using a telemetry system of the each device,
encrypts the telemetry packet with a blockchain encryption key from a blockchain encryption key storage using a blockchain security system of the each device, and
transmits the encrypted telemetry packet to a next self-propelled mobile device of the group using a transceiver of the each device, wherein the next self-propelled mobile device
(a) decrypts the received encrypted telemetry packet with a blockchain encryption key from a blockchain encryption key storage using a blockchain security system of the next device,
(b) validates the decrypted telemetry packet as a valid blockchain packet using the blockchain security system of the next device,
(c) stores the decrypted telemetry packet in a blockchain ledger storage of the next device using the blockchain security system of the next device, and
(d) transmits the received encrypted telemetry packet using a transceiver of the next device to a next self-propelled mobile device of the group, and repeats steps (a)-(d) until each blockchain ledger storage of each of the N-1 self-propelled mobile devices of the N self-propelled mobile devices includes the telemetry packet of the each device.

2. The system of claim 1, wherein the each device transmits the encrypted telemetry packet to a next self-propelled mobile device of the group using a transceiver over a peer-to-peer network.

3. The system of claim 2, wherein the each device further verifies that the telemetry packet conforms to requirements of the peer-to-peer network using a blockchain security system of the each device before encrypting and transmitting the telemetry packet.

4. The system of claim 1, wherein the each device further transmits the encrypted telemetry packet to a stationary observer device that includes that includes a wireless transceiver, a network, and a computer system that includes blockchain encryption key storage and blockchain ledger storage.

5. The system of claim 4, wherein the stationary observer device
receives the encrypted telemetry packet using the transceiver,
transmits the received encrypted telemetry packet to the computer system using the network,
decrypts the received encrypted telemetry packet with a blockchain encryption key from the blockchain encryption key storage using the computer system,
validates the decrypted telemetry packet as a valid blockchain packet using the computer system, and
stores the decrypted telemetry packet in the blockchain ledger storage using the computer system.

6. The system of claim 5, wherein the stationary observer device performs real-time traffic monitoring of the group using information stored in the blockchain ledger storage.

7. The system of claim 5, wherein the stationary observer device performs incident analysis for at one of at least one self-propelled mobile device of the group of N self-propelled mobile devices traffic monitoring group using information stored in the blockchain ledger storage.

8. The system of claim 1, wherein at least one self-propelled mobile device of group of N self-propelled mobile devices is an autonomous self-propelled mobile device.

9. The system of claim 1, wherein at least one self-propelled mobile device of group of N self-propelled mobile devices is a semi-autonomous self-propelled mobile device.

10. The system of claim 1, wherein at least one self-propelled mobile device of group of N self-propelled mobile devices is remotely controlled by an operator.

11. The system of claim 1, wherein the telemetry packet includes position information about the each device.

12. The system of claim 11, wherein the telemetry packet includes heading information about the each device.

13. The system of claim 12, wherein the each device performs collision avoidance by comparing position and heading information of the each device with position and heading information of each of the N-1 self-propelled mobile devices obtained from the telemetry packets stored in a blockchain ledger storage of the each device.

14. The system of claim 12, wherein the each device performs formation maneuvering by comparing position and heading information of the each device with position and heading information of each of the N-1 self-propelled mobile devices obtained from the telemetry packets stored in a blockchain ledger storage of the each device.

15. The system of claim 12, wherein the each device performs traffic avoidance by comparing position and heading information of the each device with position and heading information of each of the N-1 self-propelled mobile devices obtained from the telemetry packets stored in a blockchain ledger storage of the each device.

16. The system of claim 1, wherein in step (c) the next self-propelled mobile device stores the decrypted telemetry packet in a directed acyclic graph (DAG) in a blockchain ledger storage of the next device

17. The system of claim 1, wherein in step (d), if each blockchain ledger storage of each of the N-1 self-propelled mobile devices of the N self-propelled mobile devices includes the telemetry packet of the each device, the next device transmits the encrypted telemetry packet back to the each device using a transceiver the next device.

18. The system of claim 17, wherein the each device
decrypts the received encrypted telemetry packet with a blockchain encryption key from a blockchain encryption key storage using a blockchain security system of the each device,
validates the decrypted telemetry packet as a valid blockchain packet using the blockchain security system of the each device, and
stores the decrypted telemetry packet in a blockchain ledger storage of the each device using the blockchain security system of the each device.

19. A method for securely transmitting and distributing telemetry data among self-propelled mobile devices, comprising:
generating a telemetry packet using a telemetry system of each device of a group of N self-propelled mobile devices, wherein each device of the group includes a telemetry system, a blockchain security system that includes blockchain encryption key storage and blockchain ledger storage, and a wireless transceiver;
encrypting the telemetry packet with a blockchain encryption key from a blockchain encryption key storage using a blockchain security system of the each device; and
transmitting the encrypted telemetry packet to a next self-propelled mobile device of the group using a transceiver of the each device, wherein the next self-propelled mobile device
(a) decrypts the received encrypted telemetry packet with a blockchain encryption key from a blockchain encryption key storage using a blockchain security system of the next device,
(b) validates the decrypted telemetry packet as a valid blockchain packet using the blockchain security system of the next device,
(c) stores the decrypted telemetry packet in a blockchain ledger storage of the next device using the blockchain security system of the next device, and
(d) transmits the received encrypted telemetry packet using a transceiver of the next device to a next self-propelled mobile device of the group, and repeats steps (a)-(d) until each blockchain ledger storage of each of the N-1 self-propelled mobile devices of the N self-propelled mobile devices includes the telemetry packet of the each device.

20. A computer program product, comprising a non-transitory and tangible computer-readable storage medium whose contents include a program with instructions being executed on a processor to perform a method for securely transmitting and distributing telemetry data among self-propelled mobile devices, the method comprising:
providing a system for each device of a group of N self-propelled mobile devices, wherein the system comprises one or more distinct software modules, and wherein the distinct software modules comprise a telemetry module, a blockchain security module, and a communications module;
generating a telemetry packet using a telemetry module of the each device;
encrypting the telemetry packet with a blockchain encryption key from a blockchain encryption key storage using a blockchain security module of the each device; and
transmitting the encrypted telemetry packet to a next self-propelled mobile device of the group using a communications module of the each device, wherein the next self-propelled mobile device
(a) decrypts the received encrypted telemetry packet with a blockchain encryption key from a blockchain encryption key storage using a blockchain security module of the next device,
(b) validates the decrypted telemetry packet as a valid blockchain packet using the blockchain security module of the next device,
(c) stores the decrypted telemetry packet in a blockchain ledger storage of the next device using the blockchain security module of the next device, and
(d) transmits the received encrypted telemetry packet using a communications module of the next device to a next self-propelled mobile device of the group, and repeats steps (a)-(d) until each blockchain ledger storage of each of the N-1 self-propelled mobile devices of the N self-propelled mobile devices includes the telemetry packet of the each device.
